(19) United States
(12) Patent Application Publication
(10) Pub. No.: US 2010/0325900 A1
(43) Pub. Date: Dec. 30, 2010

(54) Forearm mount for reciprocating saws. (Commonly known as sawzalls)

(76) Inventor: Donald Nicholas Muckerheide, Oak Bluffs, MA (US)

Correspondence Address: Donald N. Muckerheide, P.O. Box 429, Oak Bluffs, MA, 02557-0429, US

(21) Appl. No.: 12/456,968

(22) Filed: Jun. 25, 2009

(51) Int. Cl. B23D 59/00; B23D 49/16

(52) U.S. Cl. 30/296.1; 30/392

(57) ABSTRACT

The purpose of the “Forearm Mount” is to allow the reciprocating saw, or sawzall, to be used with one hand. “The Forearm Mount” transfers the weight of the saw to the operators' whole arm so support and thus control of the saw becomes a function of the hand, wrist, elbow and shoulder. The sawzall becomes an extension of the operators' whole arm. In many situations “The Forearm Mount” provides superior control of the saw, which allows for more accurate cutting and greater safety. Safely controlling the sawzall with one hand while freeing the other hand to hold on to a ladder or other support when working overhead or to steady a work piece like PVC pipe or other things that are not secure is the purpose of the invention. The one armed overhead cutting capability of “The Forearm Mount” allows the operator to move to one side and avoid getting the sawdust in the face.

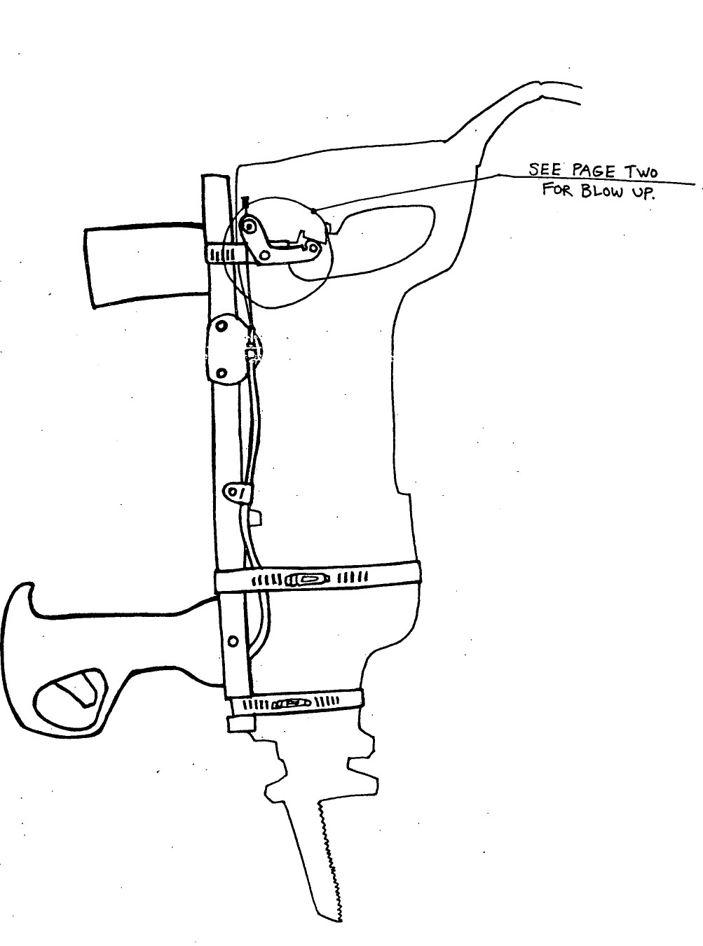

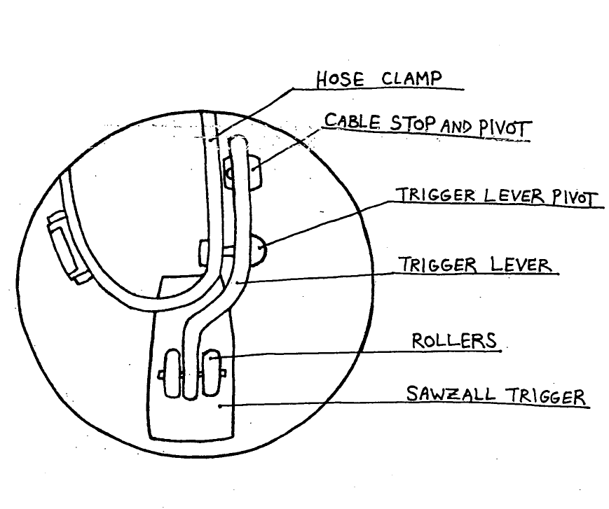

### CROSS-REFERENCE TO RELATED APPLICATIONS

Provisional patent app. No. 61/129,432

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The sawzall is a two handed saw by design. One hand goes on the trigger handle end and the other hand goes to the opposite end up by the blade. This configuration has been very successful. The need to operate the saw with two hands, however, limits its use to cutting stationary objects or objects secured in a vise. The need for two-handed control of the sawzall creates working situations that make people take chances that risk the operators safety and can result in serious lacerations and stabbing injuries. There are several safety problems with the prior art of the sawzall, which are solved by using “The Forearm Mount”. The Forearm Mount improves safety and dramatically increases the versatility of the reciprocating saw.

1. Many situations arise which tempt operators to incorrectly use the sawzall with one hand, putting the saw out of balance. One-handed use limits control of the saw and is hazardous to the operator.

2. A safety problem occurs when the operator is working from a ladder and has no available hand to hold on to the ladder or other support.

3. A safety problem occurs when the operator is cutting overhead with two hands on the saw because this position results in getting the sawdust in the face.

4. A safety problem exists when the operator tries to cut something that is not supported and they try to hold the work piece with one hand. An example is cutting pipe where you cannot use a vise.

### BRIEF SUMMARY OF THE INVENTION

The fundamental purpose of the “Forearm Mount” is to allow the reciprocating saw, or sawzall, to be used with one hand. “The Forearm Mount” allows the weight of the saw to be carried and balanced by the operators' whole arm so support and thus control of the saw becomes a function of the hand, wrist, elbow and shoulder. The sawzall becomes an extension of the operators' whole arm. In many situations “The Forearm Mount” provides superior control of the saw, which allows for more accurate cutting and greater safety. Safely controlling the sawzall with one hand while freeing the other hand to hold on to a ladder or other support when working overhead or to steady a work piece like PVC pipe or other things that are not secure is the purpose of the invention. The one armed overhead cutting capability of “The Forearm Mount” allows the operator to move to one side and avoid getting the sawdust in the face.

### BRIEF DESCRIPTION OF THE SEVERAL VIEWS OF THE DRAWING

“The Forearm Mount” consists of a backbone that attaches to the top of the sawzall at both ends and middle with hose clamps, or other quick release system. At the blade end of the sawzall the Forearm Mount has a perpendicular hand grip with a trigger that pulls a cable that goes through an adjusting barrel and connects to the trigger lever which, when pulled, pushes in the trigger of the sawzall. At the trigger end of the sawzall is an adjustable cuff or wide Velcro strap which the fat part of the operator's forearm slides into. See drawing page 1.

The Forearm Mount clamp at the trigger end of the sawzall has a machine screw through and perpendicular to the clamp band which serves as pivot and mount for the trigger lever. The trigger lever is pulled by the cable and pushes in the sawzall trigger. This pivot consists of the machine screw, washers on each side of the trigger lever and secured by a locking cap nut for adjustability. See drawing blow up page 2.

### DETAILED DESCRIPTION OF THE INVENTION

“The Forearm Mount” consists of a backbone that attaches to the top of the sawzall at both ends and middle with hose clamps, or other quick release system. At the blade end of the sawzall the Forearm Mount has a perpendicular hand grip with a trigger that pulls a cable that goes through an adjusting barrel and connects to the trigger lever which, when pulled, pushes in the trigger of the sawzall. At the trigger end of the sawzall is an adjustable cuff or wide Velcro strap which the fat part of the operator's forearm slides into. This cuff should allow the operator to drop the sawzall off of the arm if necessary.

The Forearm Mount clamp at the trigger end of the sawzall has a machine screw through and perpendicular to the clamp band which serves as pivot and mount for the trigger lever. The trigger lever is pulled by the cable and pushes in the sawzall trigger. This pivot consists of the machine screw, washers on each side of the trigger lever and secured by a locking cap nut for adjustability.

To simplify the construction concept here is the build list for the prototype. The backbone is made of mahogany. A piece of ¾ pipe supports the perpendicular trigger assembly, which I stole from a Craftsman gas weed whacker. I replaced the plastic trigger on the handle with one I made of steel. The cable and its adjusting barrel are bicycle brake parts, the barrel mount is an old brass freeze out plug, the trigger lever is hand fashioned from flat stock and is mounted through a hole in a reinforced hose clamp. A wide Velcro strap from my old Bledsoe knee brace holds the arm and the saw works great.

In a new tool design, it would be possible to incorporate the ideas presented by the Forearm Mount to create a saw that has a quickly detachable handle/trigger assembly and a clip-on forearm strap or cuff so as to eliminate the backbone and cable assembly. It would mount much like a heavy-duty version of a camera's detachable flash with a hot shoe. In such a modification of the Forearm Mount the saws' variable speed would be controlled with an electronic variable speed trigger.

The fundamental purpose of the “Forearm Mount” is to allow the reciprocating saw, or sawzall, to be used with one hand. “The Forearm Mount” allows the weight of the saw to be carried and balanced by the operators' whole arm so support and thus control of the saw becomes a function of the hand, wrist, elbow and shoulder. The sawzall becomes an extension of the operators' whole arm. In many situations “The Forearm Mount” provides superior control of the saw, which allows for more accurate cutting and greater safety. Safely controlling the sawzall with one hand while freeing the other hand to hold on to a ladder or other support when working overhead or to steady a work piece like PVC pipe or other things that are not secure is the purpose of the invention. The one armed overhead cutting capability of “The Forearm Mount” allows the operator to move to one side and avoid getting the sawdust in the face.

The Forearm Mount improves safety and dramatically increases the versatility of the reciprocating saw.

1. Many situations arise which tempt operators to incorrectly use the sawzall with one hand, putting the saw out of balance. One-handed use limits control of the saw and is hazardous to the operator.

2. A safety problem occurs when the operator is working from a ladder and has no available hand to hold on to the ladder or other support.

3. A safety problem occurs when the operator is cutting overhead with two hands on the saw because this position results in getting the sawdust in the face.

4. A safety problem exists when the operator tries to cut something that is not supported and they try to hold the work piece with one hand. An example is cutting pipe where you cannot use a vise.
In a new tool design, it would be possible to incorporate the ideas presented by the Forearm Mount to create a saw that has a quickly detachable handle/trigger assembly and a clip-on forearm strap or cuff so as to eliminate the backbone and cable assembly. It would mount much like a heavy-duty version of a camera's detachable flash with a hot shoe. In such a modification of the Forearm Mount the saws' variable speed would be controlled with an electronic variable speed trigger.
